(19) United States
(12) Patent Application Publication
(10) Pub. No.: US 2019/0352820 A1
(43) Pub. Date: Nov. 21, 2019

(54) INTERPLY HYBRID COMPOSITE BASED SINGLE CRYSTAL ALPHA-ALUMINIUM OXIDE FIBER AND PREPARATION METHOD THEREFOR

(71) Applicants: Research Institute of Tsinghua University in Shenzhen, Shenzhen (CN); Tsinghua Innovation Center in Dongguan, Dongguan (CN)

(72) Inventors: Shishan JI, Shenzhen (CN); Renchen LIU, Shenzhen (CN); Yan LIU, Shenzhen (CN); Qing MA, Shenzhen (CN); Zhen HE, Shenzhen (CN); Zuoyu SHI, Shenzhen (CN)

(73) Assignees: Research Institute of Tsinghua University in Shenhen, Shenzhen (CN); Tsinghua Innovation Center in Dongguan, Dongguan (CN)

(21) Appl. No.: 16/028,445

(22) Filed: Jul. 6, 2018

Related U.S. Application Data
(63) Continuation of application No. PCT/CN2018/088046, filed on May 23, 2018.
Application No. PCT/CN2018/088046 is a continuation of application No. PCT/CN2018/087103, filed on May 16, 2018.

(51) Int. Cl. D04H 3/004; D04H 3/12; C03C 25/36; C04B 35/628

(52) U.S. Cl. CPC D04H 3/004; D04H 3/12; C03C 25/36; D10B 2101/08; D10B 2101/06; D10B 2401/063; C04B 35/62844

(57) ABSTRACT

A interply hybrid composite based single crystal alpha-aluminium oxide fiber includes single crystal alpha-aluminium oxide fiber, glass fiber and a resin compatibilizer; a hybrid ratio of the single crystal alpha-aluminium oxide fiber to the glass fiber is 1:40 to 3:53.

### CROSS-REFERENCE TO RELATED APPLICATIONS

The continuation application claims priority to Patent Application No. PCT/CN2018/088046, filed with the Chinese Patent Office on May 23, 2018, titled “INTERPLY HYBRID COMPOSITE BASED SINGLE CRYSTAL ALPHA-ALUMINIUM OXIDE FIBER AND PREPARATION METHOD THEREFOR”, the entire contents of which are incorporated herein by reference.

### TECHNICAL FIELD

Embodiments of the present disclosure relate to the field of inorganic fiber materials, and in particular, relate to an interply hybrid composite based single crystal alpha-aluminium oxide fiber and a preparation method.

### BACKGROUND

Alpha-aluminium oxide is an alpha-alumina, which may be extensively applied for improving strength and toughness of various plastics, rubbers, ceramics, refractories and the like products due to such features as uniform particle distribution, high purity, high dispersity, low specific surface, and resistant to high temperatures and the like. Particular, the alpha-aluminium oxide achieves a significant effect in improving the compact density, finish, cold-hot fatigue property and creep resistance of the ceramics, and enhancing the wear resistance property of the polymer products.

Inorganic fiber materials pertain to polymer fibers, which mainly include glass fiber, carbon fiber, alumina fiber and the like, and inorganic compounds formed by whiskers and continuous fiber. These inorganic compounds, due to the characteristics of the material structures thereof, have some excellent properties that are not possessed by organic fiber materials. For example, these compounds may be subjected to small deformation under the effect of stress, and under a high temperature, may still maintain a high strength.

Different types of inorganic fiber materials have different features, and the mechanical properties thereof are not simultaneously satisfied. In addition, some unique species of inorganic fiber materials are expensive, and application thereof is restrictive due to the high cost. Therefore, by virtue of different hybrid solutions, composite fiber materials having different properties or composite materials with sound mechanical properties and relatively low manufacture cost are obtained by changing the components, ratios and composite structures between different inorganic fibers.

During practice of the present disclosure, the inventors have found that single crystal alpha-aluminium oxide fiber is generally selected as metal substrate enhancing material, which is used to enhance the toughness or impact resistant strength thereof.

However, since variations of the properties of the finally synthesized composite material are unpredictable, how to adjust the addition amount of the single crystal alpha-aluminium oxide fiber to achieve a fiber composite material with the best tensile property is still a problem to be urgently solved.

### SUMMARY

An embodiments of the present disclosure provides a interply hybrid composition. The interply hybrid composition comprises single crystal alpha-aluminium oxide fiber, glass fiber and a resin compatibilizer; a hybrid ratio of the single crystal alpha-aluminium oxide fiber to the glass fiber is 1:40 to 3:53.

Another embodiments of the present disclosure provides a preparation method for the interply hybrid comprises sufficiently wetting the single crystal alpha-aluminium oxide fiber and the glass fiber in the resin compatibilizer; pulling the sufficiently wetted single crystal alpha-aluminium oxide fiber and glass fiber to pass through a corresponding wire guide hole according to a predetermined interlayer hybrid structure; forming hybrid fiber having the corresponding interlayer hybrid structure in a fixing mold via the wire guide hole; and heating and curing the hybrid fiber in the fixing mold to prepare the interply hybrid composite.

### BRIEF DESCRIPTION OF THE DRAWINGS

FIG. 1 is a flowchart illustrating a preparation method for an interply hybrid composite according to an embodiment of the present disclosure; and

FIG. 2 is a scanning electron micrograph of single crystal alpha-aluminium oxide fiber according to an embodiment of the present disclosure.

### DETAILED DESCRIPTION

In order to make the objectives, technical solutions, and advantages of the present disclosure clearer, the present disclosure is further described in detail below by reference to the embodiments. It should be understood that the specific embodiments described herein are only intended to explain the present disclosure instead of limiting the present disclosure. In addition, technical features involved in various embodiments of the present disclosure described hereinafter may be combined as long as these technical features are not in conflict.

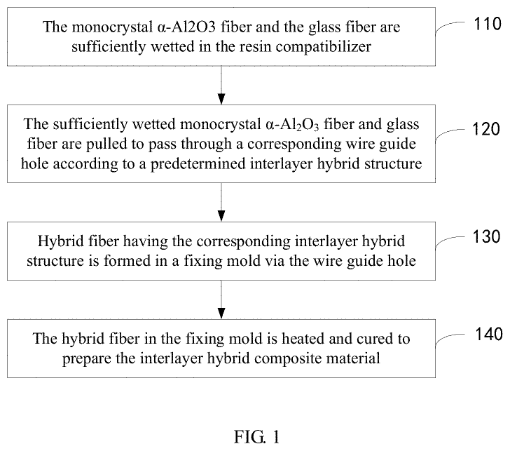

FIG. 1 illustrates a preparation method for the interlayer hybrid composite material according to an embodiment of the present disclosure. As illustrated in FIG. 1, the method may comprise the following steps:

110: The single crystal alpha-aluminium oxide fiber and the glass fiber are sufficiently wetted in the resin compatibilizer.

The single crystal alpha-aluminium oxide fiber is a single crystalline alumina whiskers having a specific aspect ratio. It is suitable for enhancing elements of ceramic, metal, plastic and rubber because of the high melting point, high strength, high wear resistance and high corrosion resistance. Therefore, as the single crystal alpha-aluminium oxide fiber is added into a metal, flexural modulus of elasticity, tensile strength, dimensional stability and thermal distortion temperature of the finished products may be significantly improved. In this embodiment, the single crystal alpha-aluminium oxide fiber may be prepared by means of Czochralski technique, Kyropoulos technique, Edge-defined Film-fed Growth (EFG) technique, heat exchange technique, temperature gradient technique, directional crystallization or the like.

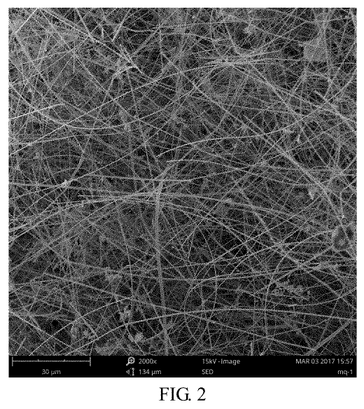

In this embodiment, the selected single crystal alpha-aluminium oxide fiber is directly placed on a conductive adhesive for SEM testing, and under an operating voltage of 15 KV and an amplification magnitude of 2000, an appearance of the obtained alpha-aluminium oxide is as shown in FIG. 2. As seen from FIG. 2, the alpha-aluminium oxide whiskers have irregular thread shapes, which have a high aspect ratio. However, the diameter dispersion of the alpha-aluminium oxide whiskers is not uniform. In addition, as seen from the scanning electron micrograph, the alpha-aluminium oxide whiskers have a tough surface, and thus the alpha-aluminium oxide whiskers having different diameters may be better applicable to subsequent enhancement of the glass fibers.

The chemical property of the single crystal alpha-aluminium oxide fiber is stable, thus issues such as chemical corrosion and the like may not occur. The single crystal alpha-aluminium oxide fiber also has high tensile strength and impact strength. In this embodiment, any suitable type of glass fiber may be used as the substrate. Optionally, borosilicate glass fiber may be adopted to reduce the cost of the composite material.

The resin compatibilizer is a bonding agent which provides the bonding capability for the composite material and blends the two fibers. Specifically, any type of resin compatibilizer having the bonding effect may be adopted.

In some embodiments, the resin compatibilizer may be selected from one or a plurality of an epoxy resin, a polyethylene elastomer, a polypropylene elastomer and a polytetrafluoroethylene elastomer.

Nevertheless, in practice use, the resin compatibilizer may be incorporated with another organic compound, for a better effect. For example, a maleic acid-grafted polyethylene elastomer may be used as the resin compatibilizer, to improve the compatibility between the single crystal alpha-aluminium oxide fiber and glass fiber.

In this embodiment, a hybrid ratio of the single crystal alpha-aluminium oxide fiber and the glass fiber is between 1:40 to 3:53, to ensure that the finally obtained composite material has the desired mechanical property.

Generally, when the alpha-aluminium oxide is added or mixed into the composite material as an enhancing phase, the addition amount is over 10%. With the addition amount of the aluminium oxide increasing, the composite material has more properties of the aluminium oxide (for example, high temperature resistance, and powerful impact resistance), and the mechanical property (for example, the bending property and the tensile property) of the metal-based fiber as the substrate or metal substrate is weakened.

In this embodiment, when the hybrid ratio of the single crystal alpha-aluminium oxide fiber is restricted to a range that is far lower than 10% and the aluminium oxide is mixed with the glass fiber (inorganic fiber), it is surprisingly found that the composite material has good heat resistance of the aluminium oxide and the mechanical property of the aluminium oxide is not significantly weakened. On the contrary, the tensile property and the bending property of the aluminium oxide are still maintained at a high level.

To ensure the compatibility of the composite material during the interlayer mixture, especially in the case where the addition amount of single crystal alpha-aluminium oxide fiber is small, in some embodiments, the diameter of the single crystal alpha-aluminium oxide fiber is controlled within a range of 0.5 μm to 1.2 μm. Preferably, the single crystal alpha-aluminium oxide fiber having a diameter of between 0.7 μm and 0.9 μm may be further used. Correspondingly, the used glass fiber has a diameter of 3 μm to 6 μm. Nevertheless, the glass fiber as the substrate may also selected within a larger range of fiber diameters, which is not limited to the range of 3 μm to 6 μm.

120: The sufficiently wetted single crystal alpha-aluminium oxide fiber and glass fiber are pulled to pass through a corresponding wire guide hole according to a predetermined interlayer hybrid structure.

The interlayer hybrid is a commonly used composite material hybrid manner in the prior art. In the interlayer hybrid, a plurality of different types of hybrid structures may also be used according to the actual needs or preferences, as long as the specific hybrid ratio requirement is satisfied.

In some embodiments, the interlayer hybrid structure is practiced by the following ways: Firstly, according to the mixture ratio, the corresponding single crystal alpha-aluminium oxide fiber and glass fiber are selected to weave into textile fabric units having the same width. Then, the textile fabric units form the corresponding interlayer hybrid structure according to a predetermined direction and distribution position.

Hence, the mixture ratio in the composite material may be correspondingly adjusted by adjusting the quantity ratio of the single crystal alpha-aluminium oxide fiber and the glass fiber in the textile fabric units.

The predetermined direction and distribution position refer to the specific weaving form of the textile fabric units in the hybrid deployment.

FIG. 2 is a schematic cross-section structural view of a composite material according to an embodiment of the present disclosure. As illustrated in FIG. 2, the black solid part indicates that the textile fabric units are longitudinally cut, and the white solid part indicates that the textile fabric units are transversely cut. In some embodiment, the predetermined direction is a 90-degree direction, and the distribution position is an alignment distribution position, such that the textile fabric units form the hybrid structure as illustrated in FIG. 2.

The interlayer hybrid structure is a layer-interleaved structure, which may provide a powerful stretching capability based on the fabric friction force in the structure. After a small amount of single crystal alpha-aluminium oxide fiber is added, in a high temperature state, the added alpha-aluminium oxide may fill up the apertures or gaps formed by interlayer hybrid such that the composite material has a better heat high temperature resistance property.

130: Hybrid fiber having the corresponding interlayer hybrid structure is formed in a fixing mold via the wire guide hole.

The wire guide hole is a through hole arranged on a wide guide plate. When the fiber is pulled to pass through different wire guide holes, the fiber may be wound and woven into the corresponding interlayer hybrid structure. The pulling force may be provided by a corresponding force supplying mechanism, for example, a corresponding pulling structure. The fiber is pulled at a specific speed to form the textile fabric units and thus the corresponding composite material is formed.

In some embodiments, the wire guide hole may be further provided with a resin scrapping device configured to remove the extra resin compatibilizer to ensure that the composite material is successfully prepared.

140: The hybrid fiber in the fixing mold is heated and cured to prepare the interlayer hybrid composite material.

After the hybrid fiber having the corresponding woven structure is obtained, the resin compatibilizer is correspondingly heated and cured, and hence a desired composite material may be prepared. The composite material may be specifically fabricated into different types of materials, for example, core materials or profile materials.

The specific heating and curing parameters may be defined by the resin compatibilizer used in step 110. For example, when the epoxy resin is used as the resin compatibilizer, the heating temperature of the heating and curing parameters is controlled within a range of 200° C. to 230° C.

In this embodiment, corresponding to the above pulling and stretching molding-based preparation method, the composite material is fabricated into core materials having a specific radius for subsequent use or testing.

The preparation process of the core materials of the composite material disclosed in the embodiments of the present disclosure is described in detail with reference to specific examples.

### First Embodiment

Firstly, a suitable amount of epoxy resin was weighed and placed into a glass reaction container and was heated at a temperature of 95° C. for 5 minutes and melted, dimethylimidazole and a curing agent were added, and the mixture was stirred uniformly to obtain a resin compatibilizer for subsequent use.

Secondly, single crystal alpha-aluminium oxide fiber and glass fiber were sufficiently wetted in the resin compatibilizer obtained in the above step.

Thirdly, according to a hybrid ratio of 1:38, a suitable number of single crystal alpha-aluminium oxide fiber and glass fibers were taken and then woven into textile fabric units having the same width by virtue of stretching and pulling. During this process, the textile fabric units were also made to pass through corresponding wire guide holes formed by virtue of stretching and pulling, and thus corresponding interlayer mixture structures were formed in a fixing mold.

Finally, the mixed fibers in the fixing mold were heated and cured at a temperature of 200° C. to 230° C., and hence a interply hybrid composite with single crystal alpha-aluminium oxide fiber having a diameter of 5.00 mm was prepared.

### Second Embodiment

Firstly, a suitable amount of epoxy resin was weighed and placed into a glass reaction container and was heated at a temperature of 95° C. for 5 minutes and melted, dimethylimidazole and a curing agent were added, and the mixture was stirred uniformly to obtain a resin compatibilizer for subsequent use.

Secondly, single crystal alpha-aluminium oxide fiber and glass fiber were sufficiently wetted in the resin compatibilizer obtained in the above step.

Thirdly, according to a mixture ratio of 2:49, a suitable number of single crystal alpha-aluminium oxide fiber and glass fibers were taken and then woven into textile fabric units having the same width by virtue of stretching and pulling. During this process, the textile fabric units were also made to pass through corresponding wire guide holes formed by virtue of stretching and pulling, and thus corresponding interlayer mixture structures were formed in a fixing mold.

Finally, the mixed fibers in the fixing mold were heated and cured at a temperature of 200° C. to 230° C., and hence a interply hybrid composite with single crystal alpha-aluminium oxide fiber having a diameter of 5.00 mm was prepared.

### Third Embodiment

Firstly, a suitable amount of epoxy resin was weighed and placed into a glass reaction container and was heated at a temperature of 95° C. for 5 minutes and melted, dimethylimidazole and a curing agent were added, and the mixture was stirred uniformly to obtain a resin compatibilizer for subsequent use.

Secondly, single crystal alpha-aluminium oxide fiber and glass fiber were sufficiently wetted in the resin compatibilizer obtained in the above step.

Thirdly, according to a mixture ratio of 3:61, a suitable number of single crystal alpha-aluminium oxide fiber and glass fibers were taken and then woven into textile fabric units having the same width by virtue of stretching and pulling. During this process, the textile fabric units were also made to pass through corresponding wire guide holes formed by virtue of stretching and pulling, and thus corresponding interlayer mixture structures were formed in a fixing mold.

Finally, the mixed fibers in the fixing mold were heated and cured at a temperature of 200° C. to 230° C., and hence an a interply hybrid composite with single crystal alpha-aluminium oxide fiber having a diameter of 5.00 mm was prepared.

### Fourth Embodiment

Firstly, a suitable amount of epoxy resin was weighed and placed into a glass reaction container and was heated at a temperature of 95° C. for 5 minutes and melted, dimethylimidazole and a curing agent were added, and the mixture was stirred uniformly to obtain a resin compatibilizer for subsequent use.

Secondly, single crystal alpha-aluminium oxide fiber and glass fiber were sufficiently wetted in the resin compatibilizer obtained in the above step.

Thirdly, according to a mixture ratio of 1:10, a suitable number of single crystal alpha-aluminium oxide fiber and glass fibers were taken and then woven into textile fabric units having the same width by virtue of stretching and pulling. During this process, the textile fabric units were also made to pass through corresponding wire guide holes formed by virtue of stretching and pulling, and thus corresponding interlayer mixture structures were formed in a fixing mold.

Finally, the mixed fibers in the fixing mold were heated and cured at a temperature of 200° C. to 230° C., and hence a interply hybrid composite with single crystal alpha-aluminium oxide fiber having a diameter of 5.00 mm was prepared.

### Fifth Embodiment

Firstly, a suitable amount of epoxy resin was weighed and placed into a glass reaction container and was heated at a temperature of 95° C. for 5 minutes and melted, dimethylimidazole and a curing agent were added, and the mixture was stirred uniformly to obtain a resin compatibilizer for subsequent use.

Secondly, single crystal alpha-aluminium oxide fiber and glass fiber were sufficiently wetted in the resin compatibilizer obtained in the above step.

Thirdly, according to a mixture ratio of 1:20, a suitable number of single crystal alpha-aluminium oxide fiber and glass fibers were taken and then woven into textile fabric units having the same width by virtue of stretching and pulling. During this process, the textile fabric units were also made to pass through corresponding wire guide holes formed by virtue of stretching and pulling, and thus corresponding interlayer mixture structures were formed in a fixing mold.

Finally, the mixed fibers in the fixing mold were heated and cured at a temperature of 200° C. to 230° C., and hence a interply hybrid composite with single crystal alpha-aluminium oxide fiber having a diameter of 5.00 mm was prepared.

### Sixth Embodiment

Firstly, a suitable amount of epoxy resin was weighed and placed into a glass reaction container and was heated at a temperature of 95° C. for 5 minutes and melted, dimethylimidazole and a curing agent were added, and the mixture was stirred uniformly to obtain a resin compatibilizer for subsequent use.

Secondly, single crystal alpha-aluminium oxide fiber and glass fiber were sufficiently wetted in the resin compatibilizer obtained in the above step.

Secondly, according to a mixture ratio of 1:5, a suitable number of single crystal alpha-aluminium oxide fiber and glass fibers were taken and then woven into textile fabric units having the same width by virtue of stretching and pulling. During this process, the textile fabric units were also made to pass through corresponding wire guide holes formed by virtue of stretching and pulling, and thus corresponding interlayer mixture structures were formed in a fixing mold.

Finally, the mixed fibers in the fixing mold were heated and cured at a temperature of 200° C. to 230° C., and hence a interply hybrid composite with single crystal alpha-aluminium oxide fiber having a diameter of 5.00 mm was prepared.

### Seventh Embodiment

Firstly, a suitable amount of epoxy resin was weighed and placed into a glass reaction container and was heated at a temperature of 95° C. for 5 minutes and melted, dimethylimidazole and a curing agent were added, and the mixture was stirred uniformly to obtain a resin compatibilizer for subsequent use.

Secondly, single crystal alpha-aluminium oxide fiber was sufficiently wetted in the resin compatibilizer obtained in the above step.

Thirdly, the single crystal alpha-aluminium oxide fiber was woven into textile fabric units having the same width by virtue of stretching and pulling. During this process, the textile fabric units were also made to pass through corresponding wire guide holes formed by virtue of stretching and pulling, and thus corresponding interlayer mixture structures were formed in a fixing mold.

Finally, the mixed fibers in the fixing mold were heated and cured at a temperature of 200° C. to 230° C., and hence a interply hybrid composite with single crystal alpha-aluminium oxide having a diameter of 5.00 mm was prepared.

### Eighth Embodiment

Firstly, a suitable amount of epoxy resin was weighed and placed into a glass reaction container and was heated at a temperature of 95° C. for 5 minutes and melted, dimethylimidazole and a curing agent were added, and the mixture was stirred uniformly to obtain a resin compatibilizer for subsequent use.

Secondly, glass fiber was sufficiently wetted in the resin compatibilizer obtained in the above step.

Thirdly, the glass fiber was woven into textile fabric units having the same width by virtue of stretching and pulling. During this process, the textile fabric units were also made to pass through corresponding wire guide holes formed by virtue of stretching and pulling, and thus corresponding interlayer mixture structures were formed in a fixing mold.

Finally, the mixed fibers in the fixing mold were heated and cured at a temperature of 200° C. to 230° C., and hence a interply hybrid composite with single crystal alpha-aluminium oxide fiber having a diameter of 5.00 mm was prepared.

### Ninth Embodiment

Core materials having a length of 5 to 10 cm were selected from the fiber hybrid composite materials prepared in the first to ninth embodiment for mechanical property analysis, and the carbon fiber-glass fiber hybrid composite material commercially available in the market was used as a control group.

The analysis of the mechanical properties covered: tensile property, shear property, bending property and loss of the tensile property under a super high temperature state (when being heated to 1200° C.). Various indicators in an analysis result of the mechanical properties were all obtained by using the standard methods for testing the tensile strength, interlayer shear strength and bending strength prescribed in the national standards, which correspondingly represent the tensile property, shear property, bending property and high temperature resistance property of the composite material.

Analysis of the mechanical properties of the materials prepared in the above eight examples and the control group are specifically as listed in the following table.

| | | Interlayer shear | Bending | Strength |
|---|---|---|---|---|
| | Tensile | strength | strength | degradation |
| embodiment | strength (MPa) | (MPa) | (MPa) | ratio (%) |
| first | 952.3 | 73.1 | 1322 | 35% |
| second | 948.1 | 69.8 | 1301 | 34% |
| third | 960.5 | 70.3 | 1228 | 34% |
| fourth | 767.3 | 72.7 | 1350 | 33% |
| fifth | 788.0 | 68.6 | 1287 | 35% |
| sixth | 802.4 | 66.4 | 1255 | 33% |
| seventh | 970.0 | 80.5 | 1157 | 30% |
| eighth | 735 | 62.8 | 1339 | 52% |
| Control | 876.7 | 76.1 | 1307 | 58% |

As seen from comparisons between first, second, third embodiment and the control group, when the single crystal alpha-aluminium oxide fiber at a low ratio is added, the high temperature resistance and tensile strength of the obtained single crystal alpha-aluminium oxide fiber-based interlayer hybrid composite material are both significantly improved, and the comprehensive mechanical property of the composite material is excellent.

As seen from comparisons between first, second, third embodiment and fourth, fifth, sixth embodiment in one aspect, the tensile property of the composite material when the addition ratio of the single crystal alpha-aluminium oxide fiber is within a low range is far better than the tensile property of the composite material when the addition ratio is high.

In another aspect, with the continuous increase of the addition ratio of the single crystal alpha-aluminium oxide fiber, the tensile property may be correspondingly improved, whereas in this case, the bending property is degraded. This phenomenon occurs because when a small amount of single crystal alpha-aluminium oxide fiber is added, the ratio coefficient between the tensile strength and the bending strength is increased since the single crystal alpha-aluminium oxide fiber may be more freely or sparsely arranged in the glass fiber substrate and interleaved in the interlayer hybrid structure. Therefore, the addition ratio of the single crystal alpha-aluminium oxide fiber is within an extremely low range, and thus better comprehensive mechanical properties are achieved.

As seen from comparisons between first embodiment, second embodiment, third embodiment, eighth embodiment and the control group, after the single crystal alpha-aluminium oxide fiber is added, the high temperature resistance property of the interply hybrid composite with single crystal alpha-aluminium oxide fiber is remarkably improved. In a super high temperature state, a good strength of the interply hybrid composite may still be maintained, and the tensile strength may be not excessively lost.

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

What is claimed is:

1. A interply hybrid composite based single crystal alpha-aluminium oxide fiber, comprising single crystal alpha-aluminium oxide fiber, glass fiber and a resin compatibilizer; a hybrid ratio of the single crystal alpha-aluminium oxide fiber to the glass fiber is 1:40 to 3:53.

2. The interply hybrid composite according to claim 1, wherein the resin compatibilizer is one or more of an epoxy resin, a polyethylene elastomer, polypropylene elastomer, and a polytetrafluoroethylene elastomer.

3. The interply hybrid composite according to claim 1, wherein a hybrid ratio of the single crystal alpha-aluminium oxide fiber to the glass fiber is 1:38, 2:49 or 3:61.

4. The interply hybrid composite according to claim 1, wherein the glass fiber has a diameter of 3 to 6 μm.

5. The interply hybrid composite according to claim 1, wherein the interply hybrid composite employs the following hybrid stacking manner:
according to the hybrid ratio, selecting the corresponding single crystal alpha-aluminium oxide fiber and glass fiber to make textile fabric units having the same width, wherein the fabric textile fabric units form a corresponding interply hybrid structure according to a predetermined direction and a distribution position.

6. The interply hybrid composite according to claim 5, wherein the predetermined direction is a 90-degree direction, and the distribution position is an aligned distribution position.

7. The interply hybrid composite according to claim 5, wherein the glass fiber is aluminum borosilicate glass fiber.

8. A preparation method for the interply hybrid composite comprising:
sufficiently wetting the single crystal alpha-aluminium oxide fiber and the glass fiber in the resin compatibilizer;
pulling the sufficiently wetted single crystal alpha-aluminium oxide fiber and glass fiber to pass through a corresponding wire guide hole according to a predetermined interlayer hybrid structure;
forming hybrid fiber having the corresponding interlayer hybrid structure in a fixing mold via the wire guide hole; and
heating and curing the hybrid fiber in the fixing mold to prepare the interply hybrid composite.

9. The preparation method according to claim 8, wherein the resin compatibilizer is epoxy resin, and the heating and curing is carried out at a temperature of 200° C. to 300° C.
